(19) United States
(12) Patent Application Publication
(10) Pub. No.: US 2012/0136918 A1
(43) Pub. Date: May 31, 2012

(54) Methods and Apparatus for Aggregating and Distributing Information

(76) Inventors: Christopher Hughes, New York, NY (US); Nick Thuesen, Brooklyn, NY (US)

(21) Appl. No.: 12/955,472

(22) Filed: Nov. 29, 2010

(51) Int. Cl. G06F 15/16

(52) U.S. Cl. 709/203; 709/201

(57) ABSTRACT

Methods and apparatus for aggregating and distributing information. A user may interact with embodiments of the present invention to access information relating to organizations/projects and issues they are interested in. For example, users may access a web portal which includes information from a wide variety of sources relating to the user's interests in certain organizations/projects and issues.

### FIELD OF THE INVENTION

The present invention relates to methods and apparatus for aggregating and distributing information, and in particular aggregating information relating to organizations/projects and issues from network sources and distributing organized information through a web portal to end users.

### BACKGROUND OF THE INVENTION

Across the globe, over one billion people live on less than a dollar a day. Living in extreme poverty, these billion people lack the capital to secure the basic essentials to live: reliable access to food, clean water, and shelter. The international community has tried countless approaches to combat economic injustice over the last 60 years, most notably imposing free-market economic reforms and providing $2.3 trillion in direct economic aid. For everyday people, however, the most important lesson is a simple one: poverty is complex.

Practical solutions to distinct problems in the field do, in fact, exist. There are non-governmental organizations, non-profits, government programs, and for-profit companies that do urgent, sustainable work in nearly every country. Yet despite enormous advances in communications technology over the past 25 years, the knowledge and expertise developed by these groups remains largely immobile and inaccessible.

This is principally an information organization and distribution problem. In a world where groups are working on a range of problems in all places and contexts, there is no central location to share work, explore outside groups and ideas, or find opportunities for collaboration. At the same time, individuals may have resources at hand—money, skills, or time—but cannot easily offer them to the people and organizations in need.

Accordingly, there is a need to connect groups with individuals by providing timely and organized information concerning the groups to interested individuals.

### SUMMARY OF THE INVENTION

Embodiments of the present invention provide methods and apparatus for aggregating information and distributing it to a relevant population. A user may interact with embodiments of the present invention to access information relating to organizations/projects and issues they are interested in. For example, users may access a web portal which includes information from a wide variety of sources relating to the user's interests in certain organizations and issues. Users may also see how others are interacting through the web portal with other organizations and issues.

In one aspect, embodiments of the present invention aggregate and distribute information by providing a server with a network interface that hosts a plurality of webpages, where each webpage is affiliated with a particular organization and each organization is associated with a plurality of properties. The method also includes intermittently communicating with network-connected information sources and retrieving content from the network-connected information sources, organizing the retrieved content in accord with the plurality of organization properties to identify retrieved content associated with at least one organization, and updating at least one webpage affiliated with a particular organization to include the organized content associated with that particular organization.

In various embodiments, the method further includes distributing the organized content to third parties having expressed an affinity for the particular organization associated with the organized content. In another embodiment, the method includes storing the retrieved content. The method may also include filtering the retrieved content prior to update. In further embodiments, filtering the content comprises sorting the retrieved content into a new content group and a duplicative content group based on at least one of similarities or dissimilarities to previously organized content and only content in the new content group is organized.

In other embodiments, the method includes specifying an account on a network-connected information resource associated with a particular organization and importing content from the network-connected information resource using the specified account. The plurality of properties may be defined by at least two disparate tags assigned by a user and organizing the content may include analyzing content based on at least one of third party comments and third party expressions of approval. In another embodiment, organizing the content comprises analyzing content based on at least one of keywords and word frequency. In yet another embodiment, the method includes soliciting each organization to designate the network-connected information sources from which the retrieved content should be associated with that organization. In still another embodiment, the method includes receiving a designation of the network-connected information sources for communication.

In another aspect, embodiments of the present invention provide a system for distributing aggregated information including a hosting server having a processor, a network interface, and a database. The server hosts a plurality of webpages in the database, where each webpage is affiliated with a particular organization and each organization is associated with a plurality of properties in the database. The hosting server utilizes the network interface to intermittently communicate with and retrieve content from network-connected information sources, and is configured to organize retrieved content in accord with the plurality of organization properties to identify retrieved content associated with at least one organization and to update at least one webpage affiliated with a particular organization to include the organized content associated with that particular organization.

In various embodiments, the hosting server is further configured to distribute the organized content to third parties that have expressed an affinity for the particular organization associated with the organized content. The hosting server may be configured to store the retrieved content and to sort the retrieved content into a new content group and a duplicative content group based on similarities or dissimilarities of the retrieved content to previously organized content. In a further embodiment, only the retrieved content in the new content group is organized.

In other embodiments, the server includes data stored in the database that specifies an account on a network-connected information resource associated with a particular organization, and the server is configured to import content from the network-connected information resource using the specified account. The server may be configured to associate at least two disparate user assigned tags with a particular organization and to analyze content based on at least one of third party comments and third party expressions of approval. In another embodiment, the server is configured to analyze content based on at least one of keywords and word frequency. In still another embodiment, the server is configured to update the webpage of a particular organization only with content from organization designated sources. In yet another embodiment, the server is configured to retrieve content only from user designated information sources.

In another aspect, embodiments of the present invention aggregate and distribute information by performing a computer-assisted survey of network-connected information sources for content relevant to a plurality of organizations, retrieving the content relevant to the plurality of organizations, organizing the retrieved content based on a plurality of organization properties to identify the retrieved content associated with at least one organization, and displaying the content associated with a particular organization on a webpage affiliated with the particular organization.

The foregoing and other features and advantages of the present invention will be made more apparent from the description, drawings, and claims that follow.

### BRIEF DESCRIPTION OF DRAWINGS

The advantages of the invention may be better understood by referring to the following drawings taken in conjunction with the accompanying description in which:

FIG. 1a is a depiction of a home page of a user interface for use in distributing aggregated information displayed when a user is not signed in;

FIG. 1b presents the interface of FIG. 1a when the user is signed in;

FIG. 2 is a depiction of an organization/project page of the user interface of FIG. 1a;

FIG. 3 is a depiction of an issue/cause page of the user interface of FIG. 1a;

FIG. 4a is a depiction of an interests page of the user interface of FIG. 1a;

FIG. 4b is a depiction of a follow page of the user interface of FIG. 1a; and

FIG. 5 is a depiction of a server for use in one aspect of the invention.

In the drawings, like reference characters generally refer to corresponding parts throughout the different views. The drawings are not necessarily to scale, emphasis instead being placed on the principles and concepts of the invention.

### DETAILED DESCRIPTION OF THE INVENTION

Embodiments of the present invention provide a method for aggregating information from a plurality of network-connected sources and distributing the information in a meaningful form to an interested population. In one exemplary form, as will be used throughout the description, the invention concerns various organizations/projects and issues, and information is distributed through a web portal.

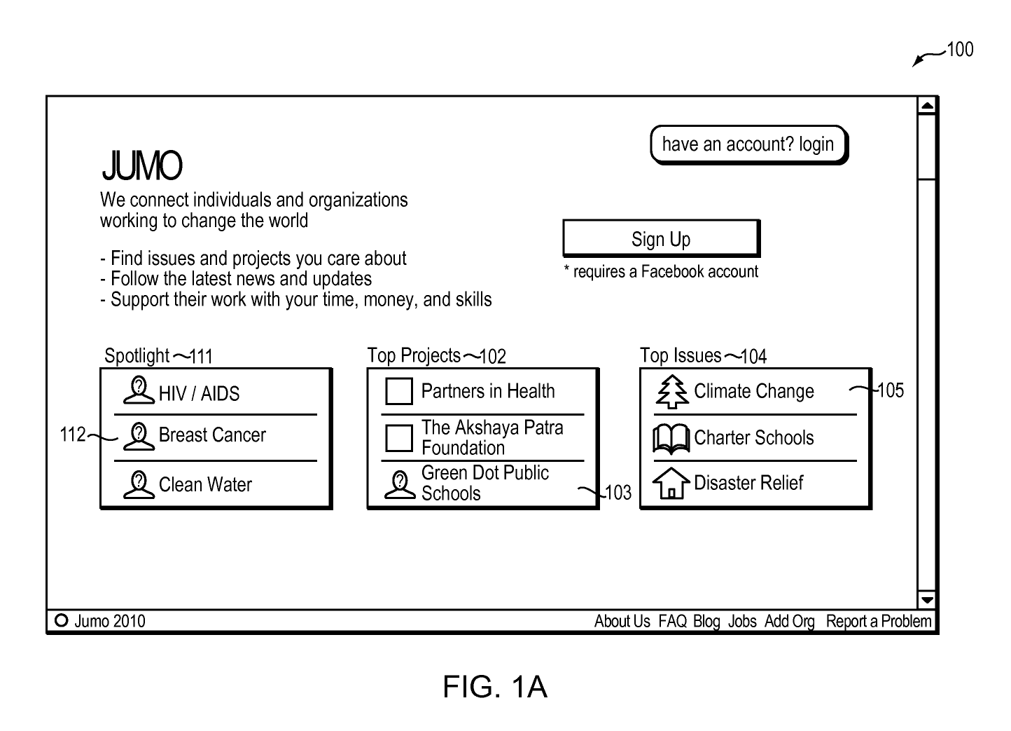

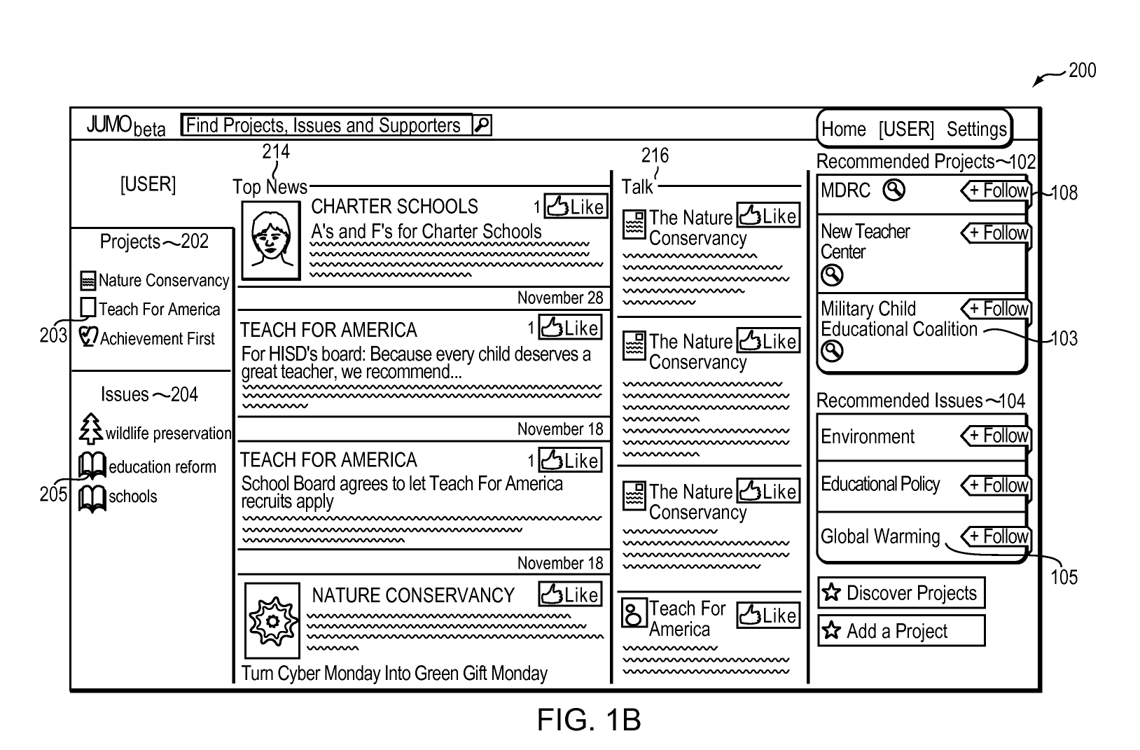

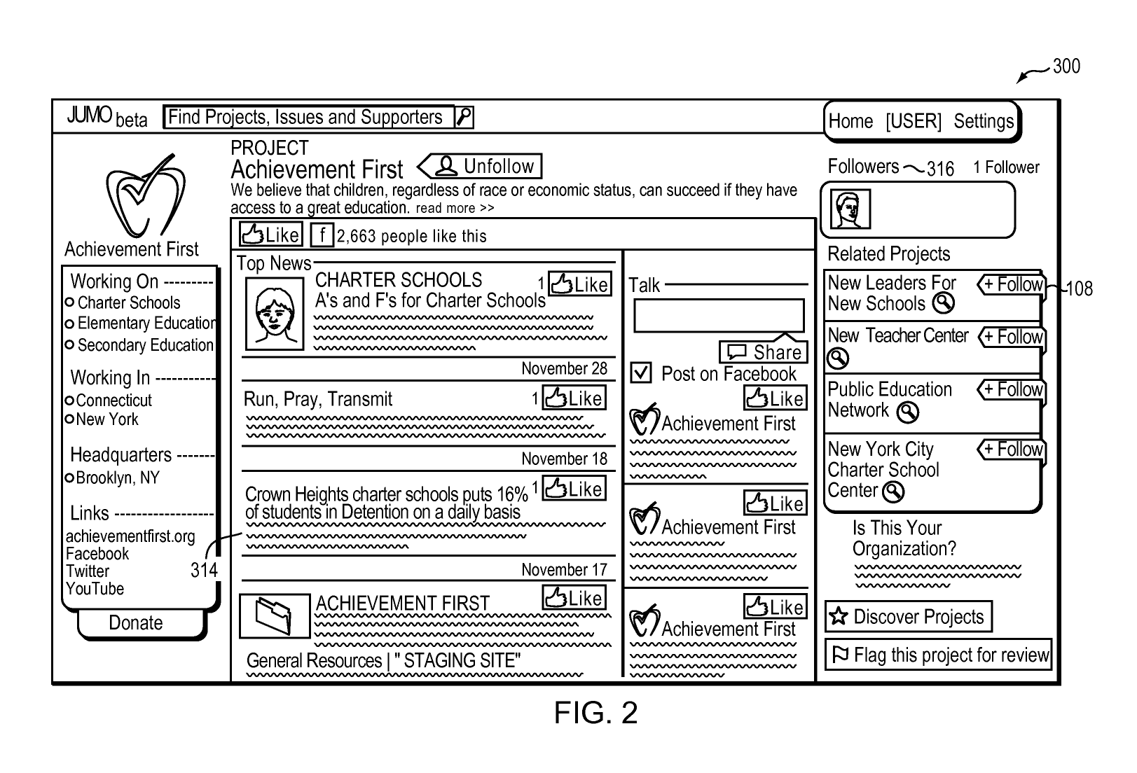

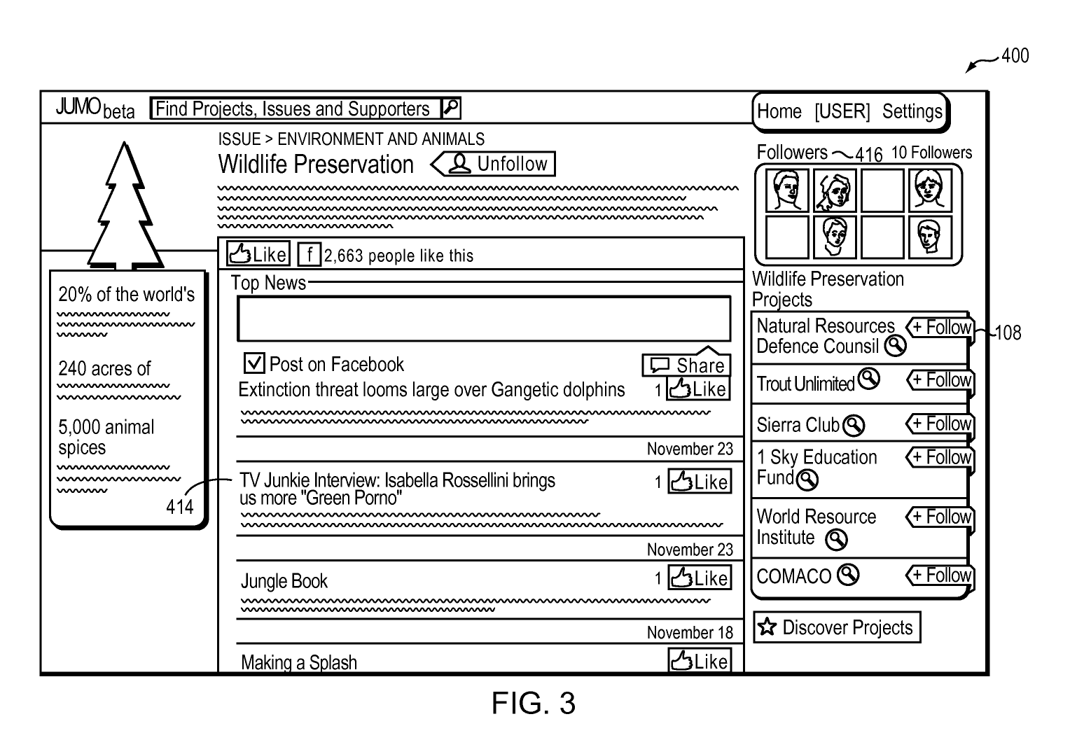

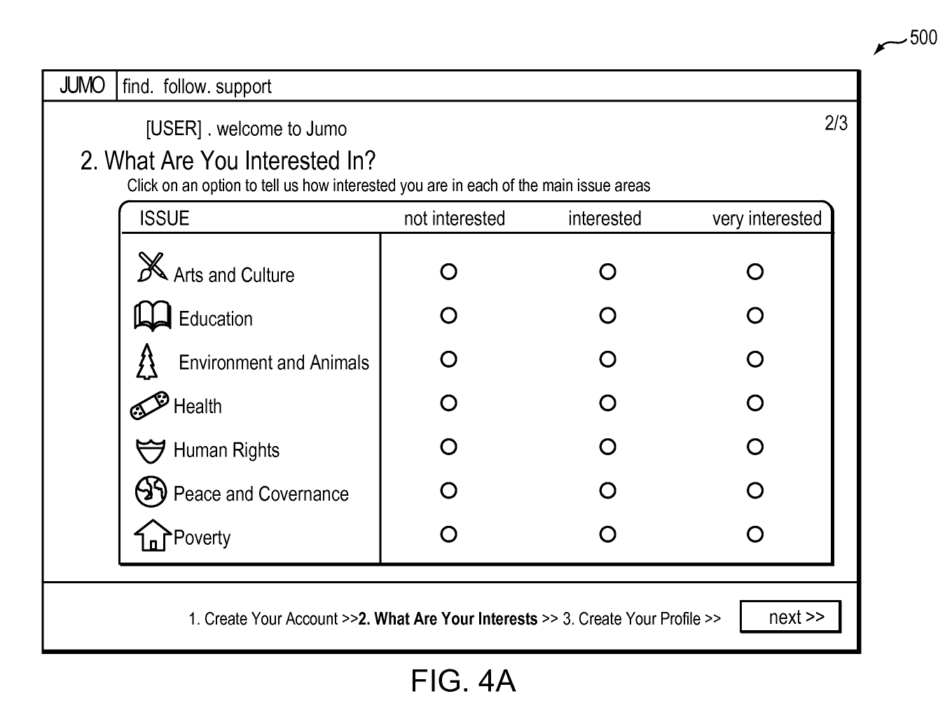

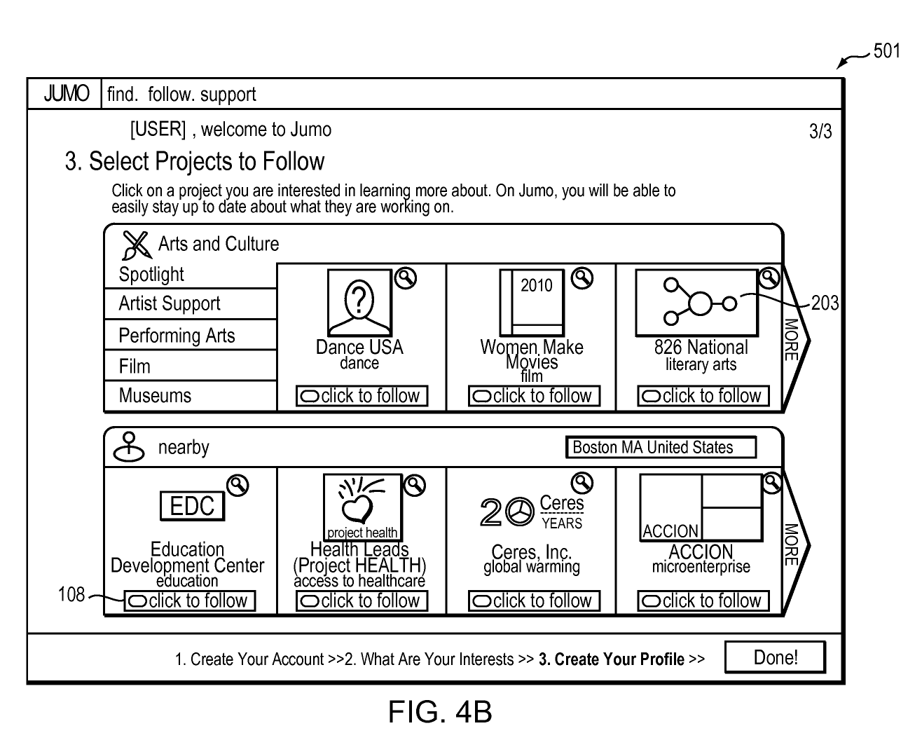

FIGS. 1a and 1b depict home pages 100, 200 of a web portal user interface that serves as a central access point for information distribution. The web portal includes many pages, including the home pages 100, 200, organization/project pages 300 with information about particular organizations/projects 103 (FIG. 2), issue pages 400 with information about particular issues (FIG. 3), and interests and follow pages 500, 501 where a user may indicate their interests and choose to follow specific organizations or issues (FIGS. 4a and 4b). The terms organization and project are interchangeable and may be used to refer to the same subject matter. Additional pages may also be included, such as pages with information relating to a particular geographical region. The web portal also permits organizations and users to register their contact information and preferences, as is known in the art. Unregistered users will initially see the base home page 100 depicted in FIG. 1a. This base home page 100 includes an organization list 102 that displays some of the organizations/projects 103 tracked by the web portal for which information content is retrieved and an issue list 104 that displays some of the issues 105 tracked by the web portal for which information content is retrieved. Context tags for a given organization 103 or issue 105 may be displayed underneath their respective entries. The process for assigning context tags is described in greater detail below. Additionally, a spotlight pane 111 may be displayed and contain selected topics 112 that may be especially relevant at a given time (e.g., breast cancer during breast cancer awareness month). Alternatively, this pane may display other information that has been aggregated for the web portal, such as a story. Each of the organization list 102, the issue list 104, and the spotlight pane 111 may be expandable by selecting a portion of the image associated with expansion, and a user may navigate to any of the associated pages by selecting one of the items. Additional information may also be displayed on the base home page 100, such as a sample of people who are registered on the site. The base home page 100 also includes a link for first-time users to sign up for access to the web portal and a link for previously registered users to sign in to their account.

FIG. 1b depicts a home page 200 for registered users that are signed-in to the web portal. The home page 200 includes a customized feed 214 that is tailored to the user. The user feed 214 is described in greater detail below. Other information may also be displayed on the home page 200, such as the organization/project list 102, a people list of people who are registered on the site, and the issue list 104. A user may indicate interest or affinity for a particular organization/project 103 or issue 105 and receive information through the web portal about that particular organization/project 103 or issue 105 by electing to follow it. A user may follow by affirmatively selecting the portion of the home page 200 which displays a “Follow” image 108 associated with the desired organization 103 or issue 105. The organization/project list 102 and the issue list 104 may be populated with organizations/projects 103 or issues 105 that are recommended based on a user's history of following related organizations/projects 103 or issues 105. Similarly, the people list may include people who follow similar organizations/projects 103 and issues 105 as the user. Data associated with the user may be used to display a followed organization/project list 202 including a user's followed organizations/projects 203, a followed issues list 204 including a user's followed issues 205, and a followed user list including a user's followed people. The followed organization list 202, the followed issues list 204, and the followed people list may be expandable or collapsible, similar to the information displays on the base home page 100.

The data associated with the user regarding what they follow may be based on an indication to follow from anywhere on the web portal, including the home page 200, an organization/project page 300, an issue page 400, or follow page 501. Each organization/project page 300 and issue/cause page 400 includes an organization/project feed 314 and issue feed 414, respectively, along with a followers list 316, 416 of the people following it. The interests page 500 may be used to solicit the user's input regarding their general interests. Based on this input, the follow page 501 may be populated with organizations 203 related to the user's interests. Organizations 203 based on a user's geographical location may also be included on the follow page 501. The user may elect to follow any of the organizations 203 listed by selecting the associated “Follow” image 108. A similar system may be used to follow specific issues 105.

The user feed 214 is tailored to each individual user. The user feed 214 includes items from the followed organizations/projects 203 and the followed issues 205. Each organization feed 314 and issue feed 414 includes a plurality of items that are each a candidate for inclusion in each individual's user feed 214. The user feed 214 may also include a talk panel 216 which incorporates comments from and about the user's followed organizations 203 and issues 205. Content for the talk panel 216 may include comments made by the organization 203 through a network connected source, or comments about the organization 203 on affiliated webpages, either through the instant web portal or other network connected sources. Information in the user feed 214 pertaining to a particular followed organization 203 or followed issue 205 may optionally be grouped together and have a graphically distinct background from adjacent entries that relate to a different topic.

The feed system is designed to generate an ordered list of information of interest for each organization/project 103. Each organization 103 has a number of properties associated with it that relate to certain aspects of the organization. These properties may be manually assigned based on a review of materials regarding the organization or other knowledge, automatically assigned based on information about the organization from a variety of sources (such as a organization's website or social networking sites), or some combination of both. The property data (also known as tag data or OrgMetaData) is stored in a database and associated with an organization. The property data may include geo tags which indicate where the organization operates, context tags which are strings that describe topics associated with the organization, and the importance level of each tag. Each issue 105 may also be assigned tags to be used in the same manner as the OrgMetaData to create a feed, as described below.

The tag data is used to identify relevant information content on network connected sources and associate that information with one or more organizations/projects. The information may originate with any of a number of sources, essentially limited only by the variety of sources connected to the network. These sources may, for example, include news organizations or aggregators, social networking sites, corporations, non-profit organizations, community groups, media companies, and others. The information may be aggregated manually by individuals indicating information of interest from sources on the network. The information may also be aggregated through an automated process, such as periodically querying relevant sources. This may include, for example, using public APIs (Application Programming Interfaces) to make a query through a YQL (Yahoo! Query Language) interface. Information may also be imported from another network-connected resource that is affiliated with the same organization. For example, an organization may specify that information from another website with which it is affiliated should be used when aggregating information concerning that organization. The information from the affiliated website may supplement information from other sources, or may be the sole source of information. Similarly, an organization may be solicited to designate what information sources have content that should be used on that organization's page 300. Either one or both of the manual and automated processes may be used for aggregation.

Each information content item that is aggregated is stored in a database and indexed so that it may be retrieved later. Additional data, such as the time when the item was crawled and when the item was created may be recorded as well. The indexing may be at least partially based on the associated property data which was used to identify it. Information content items may be filtered to create new content and duplicative content groups based on similarities or dissimilarities of the retrieved content to items already in the database. Duplicate information items may be stored in the database, or, to conserve space and processing time (such as that involved in organizing the information content items), may be eliminated.

Typically, information items which are returned through the API (referred to as Feedltems) contain several different types of data. This data can include the title of the item and a summary in the form of text strings. The timestamp, as previously discussed, indicates when the Feedltem was created. Information relating to the type of Feedltem, (e.g., the API used to generate the content or the kind of item) and the position of the Feedltem (the position the result was returned from the API, e.g., its placement in a list of news stories) may also be included. Additionally, the OrgMetaData which resulted in the return of the information as well as a link for a user to view the original item may be included.

An ordered list of Feedltems (known as an OrgStream) is created from all of the available Feedltems for a particular organization. Initially, the Feedltems are restricted to only those items matching at least in part the OrgMetaData of a given organization to create a tentative result set. Each item in the tentative result set is given a score based on a wide range of factors, such as the information's age, position, subset of the OrgMetaData used to find it, source, keywords, word frequency, and feedback from other users. Such feedback may be solicited through a voting system or other input system (such as a scaled or binary system), the results of which would be stored and could be used to alter the position of the voted on item when the item is subsequently published in other feeds. Once the items are scored, the tentative result set may be sorted according to the scores and published to the organization feed 314 on the organization page 300 to update the organization page 300 with new information. The information items may not be published all at one time or immediately when they are found. Items may be published over a period of time to create the impression of a relatively constant stream of information.

A similar process is used for creating the other feeds. For example, the issue feed 414 may be created by populating the tentative result set with FeedItems which are associated with the properties assigned to a given issue 105. The tentative result set would then be scored, sorted, and published as described above. Each user feed 214 may be created by populating the tentative result set with the FeedItems related to any of the organizations 203 and issues 205 followed by the user. This tentative result set can be scored, sorted, and published as discussed above. However, it may also be desirable to group items together that relate to the same followed organization 203 or the same followed issue 205. In this case, related items may be grouped together based on a set score range. Users may desire to see the activities of the users that they follow in their user feed 214 as well. The followed users' actions may be stored as ActionFeedltems with many of the same data properties as the FeedItems, and also some additional properties such as an actor (who is making the action), an object (the object of the action), and an action (description of the type of action performed). The ActionFeedltems are then included in the tentative result set and the process proceeds as previously described, allowing the user to see the actions of their followed users.

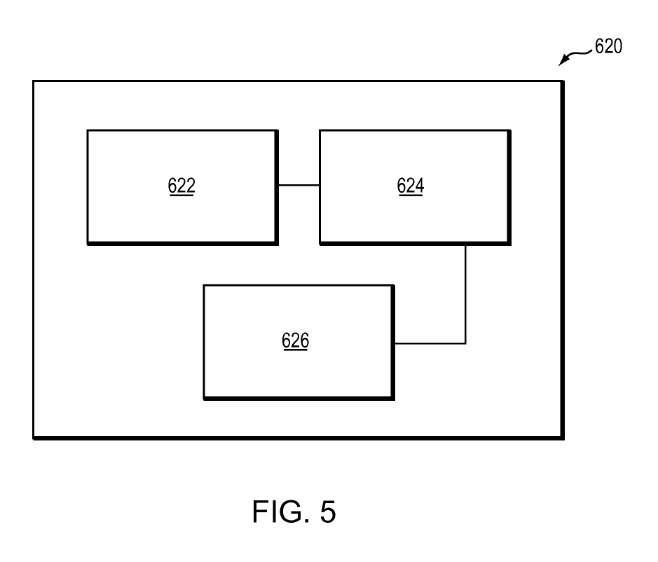

A hosting server 620 for use with one aspect of the invention is schematically depicted in FIG. 5. The server 620 includes a network interface 622, a processor 624, and a database 626. The server 620 hosts a number of the webpages described above. These webpages may be hosted in the database 626, which can be accessed by other network connected sources through the network interface 622 and the processor 624. The database 626 may be organized based on the properties of stored content, and may update the hosted webpages with the relevant stored content. Certain content (such as the public webpages) on the server 626 may be accessible to a large population, while other content (such as unpublished FeedItems) may be restricted to a limited population.

It will therefore be seen that the foregoing represents an advantageous approach to the aggregation and distribution of information. The terms and expressions employed herein are used as terms of description and not of limitation and there is no intention, in the use of such terms and expressions, of excluding any equivalents of the features shown and described or portions thereof, and it is recognized that various modifications are possible within the scope of the invention claimed.

What is claimed is:

1. A method for aggregating and distributing information comprising:
providing a server having a network interface and hosting a plurality of webpages, each webpage affiliated with a particular organization, each organization being associated with a plurality of properties;
intermittently communicating with network-connected information sources and retrieving content from said network-connected information sources utilizing said network interface;
organizing the retrieved content in accord with the plurality of organization properties to identify retrieved content associated with at least one organization; and
updating at least one webpage affiliated with a particular organization to include the organized content associated with that particular organization.

2. The method of claim 1 further comprising distributing the organized content associated with a particular organization to third parties having expressed an affinity for the particular organization associated with the organized content.

3. The method of claim 1 further comprising storing the retrieved content in a persistent memory.

4. The method of claim 1 further comprising filtering the retrieved content prior to update.

5. The method of claim 4, wherein filtering the content comprises sorting the retrieved content into a new content group and a duplicative content group based on at least one of similarities or dissimilarities to previously organized content.

6. The method of claim 5, wherein only content in the new content group is organized.

7. The method of claim 1 further comprising:
receiving a specification of an account on a network-connected information resource associated with a particular organization; and
importing content from the network-connected information resource using the specified account and said network interface.

8. The method of claim 1, wherein the plurality of properties are defined by at least two disparate tags.

9. The method of claim 1, wherein organizing the content comprises analyzing content based on at least one of third party comments and third party expressions of approval.

10. The method of claim 1, wherein organizing the content comprises analyzing content based on at least one of keywords and word frequency.

11. The method of claim 1 further comprising soliciting each organization to designate the network-connected information sources from which the retrieved content should be associated with that organization.

12. The method of claim 1 further comprising receiving a designation of the network-connected information sources for communication.

13. A system for distributing aggregated information comprising:
a hosting server having a processor, a network interface, and a database,
the server hosting a plurality of webpages in the database, each webpage affiliated with a particular organization, each organization being associated with a plurality of properties in the database,
the hosting server utilizing the network interface to intermittently communicate with and retrieve content from network-connected information sources,
the hosting server being configured to organize retrieved content in accord with the plurality of organization properties to identify retrieved content associated with at least one organization, and
the hosting server being configured to update at least one webpage affiliated with a particular organization to include the organized content associated with that particular organization.

14. The server of claim 13, wherein the hosting server is further configured to distribute the organized content associated with a particular organization to third parties having expressed an affinity for the particular organization associated with the organized content.

15. The server of claim 13, wherein the hosting server is further configured to store the retrieved content in a persistent memory.

16. The server of claim 15, wherein the hosting server is further configured to sort the retrieved content into a new content group and a duplicative content group based on at least one of similarities or dissimilarities of the retrieved content to previously organized content.

17. The server of claim 16, wherein only the retrieved content in the new content group is organized.

18. The server of claim 13 further comprising data stored in the database specifying an account on a network-connected information resource associated with a particular organization, the server further configured to import content from the network-connected information resource using the specified account and said network interface.

19. The server of claim 13 further configured to associate at least two disparate tags with a particular organization.

20. The server of claim 13 further configured to analyze content based on at least one of third party comments and third party expressions of approval.

21. The server of claim 13 further configured to analyze content based on at least one of keywords and word frequency.

22. The server of claim 13 further configured to update the webpage of a particular organization only with content from organization designated sources.

23. The server of claim 13 further configured to retrieve content only from user designated information sources.

24. A method for information aggregation and distribution, comprising:
performing a computer-assisted survey of network-connected information sources for content relevant to a plurality of organizations;
retrieving the content relevant to the plurality of organizations;
organizing the retrieved content based on a plurality of organization properties to identify the retrieved content associated with at least one organization; and
displaying the content associated with a particular organization on a webpage affiliated with the particular organization.
